(19) United States
(12) Patent Application Publication
(10) Pub. No.: US 2024/0086853 A1
(43) Pub. Date: Mar. 14, 2024

(54) International Employment Placement System and Method

(71) Applicant: Consumeron LLC, Los Angeles, CA (US)

(72) Inventor: Mark B. Barron, Bel Air, CA (US)

(73) Assignee: Consumeron LLC, Los Angeles, CA (US)

(21) Appl. No.: 18/367,187

(22) Filed: Sep. 12, 2023

Related U.S. Application Data
(60) Provisional application No. 63/406,046, filed on Sep. 13, 2022.

(51) Int. Cl. G06Q 10/1053; G06Q 50/18; G06Q 50/26

(52) U.S. Cl. CPC G06Q 10/1053; G06Q 50/18; G06Q 50/26

(57) ABSTRACT

A system and method for international employment placement establishes a network to facilitate communications and transactions between a jobseeker, an employer and/or a legal professional, wherein the jobseeker is a user looking for employment abroad, the employer is a user open to hiring a jobseeker who is a foreign national and the legal professional is a user, such as a legal firm or other entity like an immigration lawyer, qualified to assist the jobseeker with applying for employment authorization. The overall arrangement effectively enables direct networking of the foreign jobseekers, employers looking to hire foreign workers and legal personnel who are in a position to address governmental and other regulations to effect the transaction.

### CROSS-REFERENCE TO RELATED APPLICATIONS

This application claims priority to U.S. Provisional Patent Application No. 63/406,046 filed Sep. 13, 2022, entitled “International Employment Placement System and Method”, which is incorporated herein by reference.

### BACKGROUND OF THE INVENTION

The internet has become one of the most popular resources for finding a job. However, current web sites and mobile device applications that are devoted to job searching are typically national in focus rather than global. In addition to having fewer online resources for finding jobs abroad, those seeking employment in another nation are usually faced with needing to obtain employment authorization to work legally within that nation. In many instances, obtaining employment authorization involves finding an employer willing to sponsor the foreign national jobseeker.

### SUMMARY OF THE INVENTION

The present invention is directed to a system and method for international employment placement that facilitates communications and transactions between a jobseeker, an employer and/or a legal professional. In a preferred embodiment, the employer is willing to sponsor the work authorization of the jobseeker and the present invention facilitates the work authorization process with the aid of a legal professional.

A system for international employment placement in accordance with the present invention includes computing devices, a host server that stores a database and a website or application, and a network (e.g., the internet) that provides communication between the computing devices and the host server. The website or application facilitates the creation of and access to information related to international employment placement that is stored on the database. Such information is created by a user providing input via their respective computing device and is directly accessed by a user via their respective computing device. The information related to international employment placement includes information about one or more jobseekers, information about one or more employers, and information about one or more legal professionals.

In one preferred embodiment, the website or application is configured to send, to one or more employers, information about one or more jobseekers that is stored on the database. The website or application can be configured to send this information upon receiving a request from a user (e.g., a jobseeker). In another embodiment, the website or application is configured to facilitate communication or a transaction (e.g., payment) between a jobseeker, an employer and/or a legal professional. In one embodiment, the website or application is configured to facilitate bidding by one or more legal professionals on work authorization services for one or more jobseekers and/or employers.

A method for international employment placement in accordance with the present invention includes storing information about a jobseeker, information about an employer and information about a legal professional. In one embodiment, storing the information includes storing the information in a database located on a host server that also includes a website or application. The method can include creating the information about the jobseeker, the information about the employer and/or the information about the legal professional that is stored in the database. In another embodiment, the method further includes accessing the information about the jobseeker, the information about the employer and/or the information about the legal professional that is stored in the database.

In certain embodiments, the method further includes facilitating communication or a transaction (e.g., payment) between a jobseeker, an employer and/or a legal professional. Preferably, facilitating communication or a transaction includes using a web site or application. The method can also facilitate the bidding by one or more legal professionals on work authorization services for one or more jobseekers and/or employers.

Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

FIG. 1 is a scheme for a system for international employment placement in accordance with the present invention.

### DETAILED DESCRIPTION OF THE INVENTION

For purposes of this description, some reference will be made to the drawing in describing numerous preferred features which can be employed in part, or in any combination, in establishing a system which can be used for international employment placement. Certainly, it should be understood that aspects of the invention could be realized in various forms.

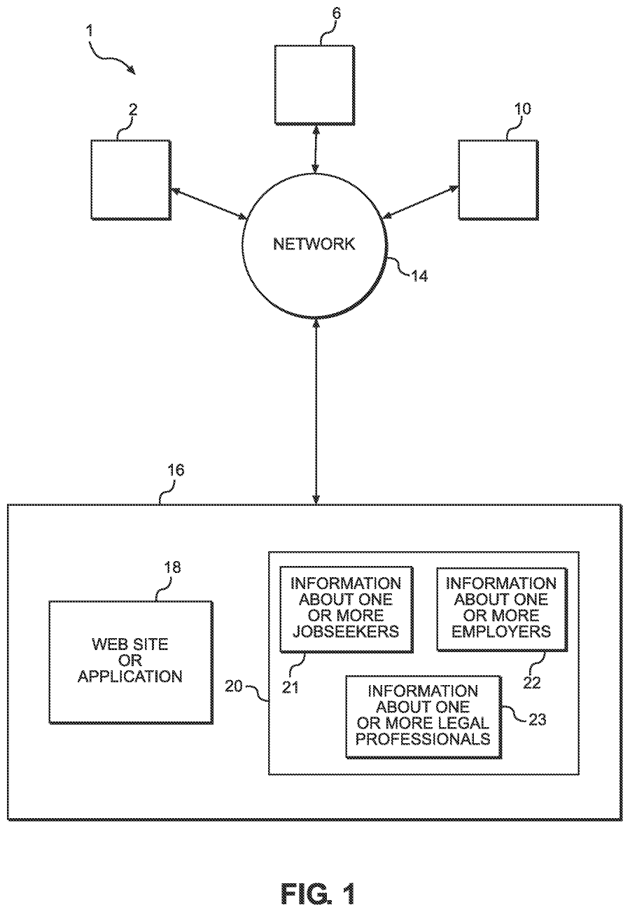

With initial reference to FIG. 1, a system 1 for international employment placement in accordance with the present invention includes computing devices 2, 6 and 10 for a jobseeker, an employer and a legal professional, respectively (collectively, users). Preferably, a jobseeker is a user looking for employment abroad, an employer is a user open to hiring a jobseeker who is a foreign national and a legal professional is a user qualified to assist a jobseeker who is a foreign national with applying for employment authorization (e.g., an immigration lawyer or law firm). Employers preferably include recruiters. Employers also include parties that compensate or incentivize a legal professional for their assistance with applying for employment authorization for one or more jobseekers, which lowers the initial cost for job seekers qualifying for citizenship. System 1 further includes a network 14 (e.g., the internet) that provides communication between computing devices 2, 6 and 10 and a host server 16 that stores a website or application 18 and a database 20.

Computing devices 2, 6 and 10 are electronic devices each configured with a user interface (not shown in FIG. 1) to interact with the users. Examples of computing devices 2, 6 and 10 include, but are not limited to, a personal computer (PC), a mobile phone, a tablet device, a personal digital assistant (PDA), a smart phone, a computer kiosk and a laptop. Examples of the user interface include, but are not limited to, a display screen, a keyboard, a mouse, and/or a stylus. In certain forms, the user interface (e.g., for computing device 2 for a jobseeker) includes an eye scanner, a fingerprint scanner and/or a handprint scanner.

Website or application 18 facilitates the creation of and access to information related to international employment placement that is stored on database 20. Such information is created by user input via their respective computing device and is directly accessed by a user via their respective computing device. The information related to international employment placement includes information 21 about one or more jobseekers, information 22 about one or more employers, and information 23 about one or more legal professionals.

Information 21 about a jobseeker can include resume-related information, e.g., a description of acquired education, a detailed description of work experience and/or professional skills. Information 21 about the jobseeker can also include availability, race, nationality, geographic location, religion and/or sex information, all depending on relevant permissibility laws. In one embodiment, information 21 about the jobseeker includes one or more referrals by other jobseekers and/or one or more referrals by employers that testify to the jobseeker's ability or reliability. Jobseekers who have used application 18 are also able to input information such as referring other individuals or family members. Website or application 18 is configured to facilitate the creation of such referrals. Information 21 about the jobseeker can include information created by the jobseeker using their respective computing device 2. In one embodiment, information 21 about the jobseeker includes eye scan information (e.g., iris images), fingerprint scan information and/or handprint scan information (e.g., obtained via the user interface of the jobseeker's computing device 2). Information 21 about the jobseeker can also include the jobseeker's history with immigration law enforcement (e.g., arrest, deportation and/or prosecution records).

Information 22 about the employers can include job vacancies, willingness to sponsor a jobseeker's work authorization and/or areas of specialty. Information 23 about the legal professionals can include national association and ratings based on, e.g., track records for accurate applications for legal work authorization. Such ratings can be accessed by jobseekers and/or employers.

In accordance with a preferred embodiment, website or application 18 is configured to send, to one or more employers, information 21 about one or more jobseekers that is stored on database 20. Website or application 18 is preferably configured to send information 21 upon receiving a request from a user (e.g., a jobseeker). In another embodiment, website or application 18 is configured to provide, from information 21, a list of any jobseekers seeking employment placement and/or sponsorship for work authorization, a list of any jobseekers who have references, and/or a list of any jobseekers that have a history with immigration law enforcement (e.g., arrests, deportation and/or prosecution records).

Website or application 18 is configured to facilitate communication or a transaction (e.g., payment) between a jobseeker, an employer and/or a legal professional. In a preferred embodiment, an employer is willing to sponsor the work authorization of the jobseeker and website or application 18 is configured to facilitate the work authorization process. In another preferred embodiment, website or application 18 is configured to facilitate bidding by one or more legal professionals on work authorization services for one or more jobseekers and/or employers. In yet another preferred embodiment, website or application 18 is configured to facilitate bidding by one or more legal professionals on a group of jobseekers (e.g., having jobseekers of a particular nationality and/or for employment by particular employer) to save on costs for preparing applications for work authorization for the jobseekers. The legal professionals bundle legal work so that the cost for preparing legal citizenship documents is spread over several jobseekers with similar backgrounds, resulting in a cost savings. In certain embodiments, website or application 18 is configured to facilitate payment of one or more legal professionals for employment authorization services (e.g., payment by one or more employers). Website or application 18 can be configured to facilitate communications regarding and/or establishing a contract detailing, as a condition of employment placement, an employer withholding a percentage of a placed jobseeker's (i.e., a new employee's) earned income for legal fees associated with the services of the legal professionals.

A method for international employment placement in accordance with the present invention includes storing information about a jobseeker, information about an employer and information about a legal professional. Preferably, storing the information includes storing the information in a database located on a host server that also includes a website or application.

The method further includes creating the information about a jobseeker, the information about an employer and/or the information about a legal professional. Preferably, the information about a jobseeker, the information about an employer and/or the information about a legal professional is created using one or more computing devices. In one preferred embodiment, creating information about a jobseeker includes creating a reference for the jobseeker. In another preferred embodiment, creating information about a jobseeker includes inputting eye scan information (e.g., iris images), fingerprint scan information and/or handprint scan information. In yet another preferred embodiment, creating information about a jobseeker includes inputting a jobseeker's history with immigration law enforcement (e.g., arrest, deportation, prosecution records). Creating information about an employer preferably includes inputting one or more job vacancies, the employer's willingness to sponsor a jobseeker's work authorization and/or the employer's one or more areas of specialty. Creating information about a legal professional can include inputting the legal professional's national association and/or the legal professional's rating based on, e.g., track records for accurate applications for legal work authorization. The legal professional is rated statistically based on the history and track record of previous work to verify the work is being done professionally and accurately.

In another preferred embodiment, the method further includes accessing the information about a jobseeker, the information about the employer and/or the information about a legal professional. Preferably, accessing the information includes accessing a database located on a host server that also includes a website or application. In one preferred embodiment, accessing the information includes communicating with the host server via a network using one or more computing devices. In another preferred embodiment, accessing the information includes sending, to one or more employers, information about one or more jobseekers. Preferably, sending the information about one or more jobseekers includes using the website or application to request the information be accessed from within the database. In yet another preferred embodiment, sending the information about one or more jobseekers includes providing a list of any jobseekers seeking employment placement and/or sponsorship for work authorization, a list of any jobseekers who have references, and/or a list of any jobseekers that have a history with immigration law enforcement (e.g., arrests, deportation and/or prosecution records).

In certain embodiments, the method further includes facilitating communication or a transaction (e.g., payment) between a jobseeker, an employer and/or a legal professional. Preferably, facilitating communication or a transaction includes using a web site or application. In a preferred embodiment, an employer is willing to sponsor the work authorization of the jobseeker and method includes facilitating the work authorization process. The method preferably includes facilitating the bidding by one or more legal professionals on work authorization services for one or more jobseekers and/or employers. In particular, the method preferably includes facilitating bidding by one or more legal professionals on a group of jobseekers (e.g., having jobseekers of a particular nationality and/or for employment by particular employer) to save on costs for preparing applications for work authorization for the jobseekers. The method also facilitates payment of one or more legal professionals for employment authorization services (e.g., payment by one or more employers). The method also preferably includes facilitating communications regarding and/or establishing a contract detailing, as a condition of employment placement, an employer withholding a percentage of a placed jobseeker's (i.e., a new employee's) earned income for legal fees associated with the services of the legal professionals.

Although described with reference to preferred embodiments of the invention, it should be understood that various changes and/or modification can be made without departing from the invention.

What is claimed is:

1. A system for international employment placement comprising:
a first database containing information on a jobseeker constituting an individual having a certain set of employable skills and looking for employment abroad;
a second database containing information on an employer open to hiring the jobseeker who is a foreign national;
a third database containing information on a legal professional desiring to assist the jobseeker in obtaining a job abroad with the employer; and
a link configured to network the jobseeker, the employer and the legal professional with a purpose of arranging for the jobseeker to legally obtain employment from the employer abroad.

2. The system of claim 1, wherein the link includes a website or app.

3. The system of claim 2, wherein the website or app is on at least one of a network server, a personal computer (PC), a mobile phone, a tablet device, a personal digital assistant (PDA), a smart phone, or a laptop.

4. The system of claim 3, wherein the purpose includes further seeking citizenship for the jobseeker in a country of employment.

5. The system of claim 1, wherein the link is configured to enable direct networking of foreign jobseekers, employers looking to hire foreign workers, and legal personnel who are in a position to address governmental and other regulations to effect the transaction.

6. The system of claim 5, wherein the first database includes information about one or more referrals by other jobseekers and/or one or more referrals by employers that testify to a particular jobseeker's ability or reliability.

7. The system of claim 1, wherein the first database includes a description of acquired education, a detailed description of work experience and/or professional skills of the jobseeker.

8. The system of claim 7, wherein the first database includes eye scan information, fingerprint scan information and/or handprint scan information for the jobseeker.

9. The system of claim 8, wherein the first database includes immigration law enforcement history information for the jobseeker.

10. The system of claim 8, wherein the first database includes one or more of availability, race, nationality, geographic location, religion and/or sex information about the jobseeker.

11. The system of claim 1, wherein the second database includes information on job vacancies, willingness to sponsor a jobseeker's work authorization and/or areas of specialty.

12. The system of claim 1, wherein the system includes a network server storing the first and second databases, and a host server configured to enable networking between the jobseeker, the employer and the legal professional.

13. A method for international employment placement comprising:
establishing a first database containing information on a jobseeker constituting an individual having a certain set of employable skills and looking for employment abroad;
establishing a second database containing information on an employer open to hiring a jobseeker who is a foreign national;
establishing a third database containing information on a legal professional desiring to assist the jobseeker in obtaining a job abroad with the employer; and
using a link configured to network the jobseeker, the employer and the legal professional with a purpose of arranging for the jobseeker to legally obtain employment from the employer abroad.

14. The method of claim 13, wherein the link is established using a computer app accessed by the jobseeker, the employer and the legal professional.

15. The method of claim 14, wherein the computer app is on at least one of a network server, a personal computer (PC), a mobile phone, a tablet device, a personal digital assistant (PDA), a smart phone or a laptop

16. The method of claim 13, wherein the purpose includes further seeking citizenship for the jobseeker in a country of employment.

17. The method of claim 13, wherein establishing the first database includes storing information about one or more referrals by other jobseekers, one or more referrals by employers that testify to a particular jobseeker's ability or reliability, a description of acquired education, a detailed description of work experience, professional skills of the jobseeker and/or one or more of availability, race, nationality, geographic location, religion and/or sex information about the jobseeker.

18. The method of claim 13, wherein establishing the second database includes storing information on job vacancies, willingness to sponsor a jobseeker's work authorization and/or areas of specialty.

19. The method of claim 13, wherein establishing the third database includes national association and legal ratings for the legal professional.

20. The method of claim 13, further comprising facilitating bidding by one or more legal professionals on work authorization services for one or more jobseekers and/or employers.
